(19) United States
(12) Patent Application Publication
(10) Pub. No.: US 2025/0241814 A1
(43) Pub. Date: Jul. 31, 2025

(54) SYSTEM FOR DETERMINING AND DISPLAYING LIMITATIONS WHEN OPERATING MEDICAL TABLES

(71) Applicant: MAQUET GMBH, Rastatt (DE)

(72) Inventors: Thibaut REMPP, Haguenau (FR); Andreas Puder, Rastatt (DE); Tim GOLDE, Weingarten (DE); Rodrigo DEL ALCAZAR VON BUCHWALD, Waldbronn (DE)

(21) Appl. No.: 19/109,992

(22) PCT Filed: Sep. 8, 2023
(86) PCT No.: PCT/EP2023/074707

§ 371 Date: Apr. 11, 2025

(30) Foreign Application Priority Data
Sep. 9, 2022 (DE) 10 2022 122 929.7

(51) Int. Cl. A61G 13/08

(52) U.S. Cl. CPC A61G 13/08; A61G 2203/12; A61G 2203/20; A61G 2203/44; A61G 2203/70

(57) ABSTRACT

A system for determining and displaying restrictions during operation of an operating table, wherein the system comprises: a patient support device, in particular a surgical patient support device, for fastening to an operating table column of an operating table; a display unit for displaying information on restrictions during operation of the operating table; an input unit for inputting information on the weight of a patient and/or an interface for receiving electronic patient weight information from outside the system; and an evaluation unit formed to determine restrictions during operation of the operating table based on at least the patient weight, and to display the restrictions on the display unit before placing the patient on the patient support device.

### TECHNICAL FIELD

The present disclosure relates to medical and surgical tables where the tabletop and/or segments of the tabletop are movable. In particular, it relates to systems which can determine and display restrictions observed during operation of medical tables.

### BACKGROUND OF THE DISCLOSURE

Operating tables serve to support a patient, for example during a surgical procedure. At present, due to the flexibility when setting up the operating table, the number of accessories and the various patient positioning possibilities the operating table offers, nurses and doctors have to consider many important aspects to be able to use the operating table correctly. Some of these aspects are listed below:
The accessories used should be tailored to the patient weight.
The configuration of the accessories should also be tailored to the patient weight.
The patient support device on which the patient is located should be displaced within allowable limits only.
If a movement restriction applies, it should be made sure that the allowable limits are at no time exceeded.
When adjusting the operating table, it should be made sure that the operating table does not collide with an external object, e.g., a C-arm.
Furthermore, when adjusting the operating table, it should be made sure that the patient is correctly secured and does not fall or slide from the operating table.

Important information on the points listed above are listed in the user manual of the operating table. If the operator ignores the user manual or does not pay enough attention to collisions and the patient, the following dangerous events can occur:
Tipping of the operating table: Fall of the patient which can result in lasting injuries or even death.
Overload of structural parts of the accessories and of the operating table: This can result in the structural parts bending permanently or breaking and causing lasting injuries or even the death of the patient.
Overload of the motorised joints: Causes limited mobility as the operating table is not able to move.
Collision of the operating table with an external object: During movement, the operating table can collide and damage expensive equipment, e.g., C-arms.
Fall of the patient: If the patient is not sufficiently secured, the patient can start to slide during table movements, which in the worst case can result in the patient falling to the floor.

Patient support devices of operating tables can have exchangeable, detachably connectable segments, such as, in particular, accessories. Often, some or all of the exchangeable segments are movable. Through the use of various exchangeable segments, a single operating table can be reconfigured in different ways for various patients and medical methods. Moreover, individual segments or the entire patient support device can be adjusted in various ways. For example, individual segments or the entire patient support device can be trended or tilted, or displaced in the longitudinal or lateral direction. However, this means that the size, shape, dimensions, weight and strength of the individual operating tables are different at various times. To be able to prevent any tipping of the operating table or overload of individual structural parts or of the entire operating table, the patient support device and its segments should only be adjusted within certain limits.

Currently, the operator has to check what type of movements are permissible with a combination of accessories depending on the work load, i.e., the patient weight and the weight of the accessories used.

In practice, the operator has to ascertain the accessories attached to the operating table and their technical data, such as weight, maximum load, permissible combinations with the operating table and/or other accessories, and manually calculate or estimate the current work load. Only thereafter can the position limits of the operating table be determined.

Since there is no assistance from the operating table, this method is very prone to errors due to the variety of different operating table configurations. Given the complexity of the physical boundary conditions, it is challenging for the operator to correctly determine the actual limit values indicated in the manuals of the operating table and the accessories.

A solution to the problem described is to enter all possible configurations of the operating table and their corresponding restrictions into a database. Since the maintenance of such a database is difficult during the long service life of an operating table and also consumes a lot of storage space on the embedded systems, the realisation of such a database is very expensive both for the apparatus and for the project resources. Further, to make the database maintenance-friendly, manual discretisation of the value ranges is necessary, which is also prone to errors. The discretisation also results in a less optimal solution, which restricts the attainable position of the operating table to a greater extent than is required for the safety of the system and of the patient.

### SUMMARY OF THE DISCLOSURE

It is an object of the present disclosure to provide a system which, even before placing the patient on the patient support device, gives the operator feedback regarding the restrictions to which the operating table is subject.

According to a first aspect of the present disclosure, a system is envisaged which is adapted for determining and displaying restrictions during operation of an operating table. The system can have a patient support device, a display unit, and an evaluation unit. Moreover, the system can have an input unit and/or an interface for receiving electronic data.

The patient support device can be used as a part of an operating table and can serve to support a patient. The patient support device can be envisaged for fastening to an operating table column of the operating table. In some designs, the patient support device can be a surgical patient support device on which a patient is supported during a surgical procedure. Further, the patient support device can serve to fasten accessories. The patient support device can be formed modularly and have a supporting surface main section which can be extended by coupling miscellaneous supporting surface subsections thereto. The supporting surface main section and the supporting surface subsections can have mechanical connecting elements which can be used to detachably connect the supporting surface main sections and subsections. Supporting surface subsections can be leg, foot, or head sections, for example. Moreover, supporting surface subsections can also be extension or intermediate sections which are inserted between the supporting surface main section and the head section, for example. Sliding or lateral rails can be attached to the sides of the supporting surface main sections and subsections. Accessories can be detachably fastened to the sliding or lateral rails.

In some designs, the patient support device can be fixedly connected to a column of an operating table. The operating table can be movable. A foot or a base of the operating table may feature wheels or rollers which can be used to move the operating table on the floor. Alternatively, the foot or the base can be fixedly anchored to the floor.

In some designs, the patient support device can be designed such that it can be detachably connected to a movable surgical patient transport trolley and a column of an operating table. Before a surgical procedure, the patient support device can be mounted on the patient transport trolley. The patient can be brought to the operating table using the patient transport trolley. There, the patient support device can be fastened to the operating table column and be decoupled from the patient transport trolley. A large part of the preparations for the surgical procedure can be done while the patient support device is mounted on the patient transport trolley. For example, the patient support device can be assembled from individual segments and accessories and the patient can be prepared for the surgical procedure. Only when the preparations are completed, the patient support device can be fastened to the operating table column.

Information on the restrictions which are to be observed during operation of the operating table can be presented by the display unit, for example in the form of text and/or graphically. This enables the operator of the operating table to easily capture the restrictions. The display unit can display the information before placing the patient on the patient support device.

The display unit can be integrated into a component of the system, for example into a remote control of the operating table, in the form of a display. The remote control can also display other information on the patient support device or a table arrangement with the patient support device. The remote control can further receive inputs and commands from an operator for controlling the patient support device or a table arrangement with the patient support device. The display unit can also be a multi-purpose monitor or screen for the operating theatre. Moreover, the display unit can be a monitor or screen which is attached to a ceiling suspension arm or to a wall of an operating theatre or of another medical room. The same monitor or screen can also be used to display other information relevant to an integrated operating theatre (for instance, videos, the vital values of the patient and/or information on lights, tables, and other medical apparatuses). Integrating the display unit into the patient support device is also conceivable.

To the input unit, the operator can input information on the weight of a patient supported or yet to be supported on the patient support device. The input unit can be integrated, for example, into a remote control which optionally also displays the restrictions, into the patient support device, or into a table column which bears the patient support device. Additionally or alternatively, the system may feature an interface for receiving electronic patient weight information from outside the system. The patient weight information can be stored, for example, in a database and can from there be communicated to the system via the interface.

It can be envisaged that the weight information, which is input to the input unit or electronically received via the interface, includes the actual weight of the patient, which has previously been measured, for example, or the estimated weight. Moreover, a weight range or a minimum or maximum weight value can be input to the input unit or electronically received via the interface instead. This enables safe operation of the operating table even if the actual weight of the patient is not known with sufficient certainty.

The evaluation unit can be formed to determine restrictions during operation of the operating table. The evaluation unit can determine the restrictions based at least on the weight of the patient. The weight information input to the input unit or the weight information received electronically via the interface can be used as the patient weight. The restrictions can be displayed on the display unit. The evaluation unit can ascertain the restrictions before placing the patient on the patient support device. Moreover, the restrictions can also be displayed on the display unit before placing the patient on the patient support device.

The information produced by the evaluation unit and presented on the display unit notify the operator of the patient support device of the restrictions to which the operating table is subject during the planned procedure. This spares the operator the need to thoroughly examine the operating instructions of the patient support device.

In some designs, the evaluation unit can determine the restrictions, in particular limit values or position limits for the movements of the operating table or its components, by the evaluation unit simulating movements of the operating table with the patient supported thereon. For each joint about which a movement can be executed, a movement can be simulated, and it can be checked in which region of the joint a movement is not permissible, since a movement in this region could, for example, cause an increased tipping risk or overload of at least one component of the operating table due to the patient weight. In the same way, it can also be checked, for example, how far the patient support device can be displaced longitudinally or laterally without the tipping risk or the overload risk exceeding a specified threshold. In a similar manner, all possible movements of the operating table and/or of the patient support device and/or of the operating table column can be checked computationally. Regions with an increased tipping and/or overload risk can be excluded by stipulating suitable restrictions for operation of the operating table.

If a weight range has been input to the input unit rather than a discrete weight value, or such a weight range has been received via the interface, the evaluation unit can determine the restrictions during operation of the operating table from the weight range. For example, the evaluation unit can take the highest value of the weight range or a mean value of the indicated weight range to ascertain the restrictions. It is also conceivable for several different restrictions to be ascertained for the weight range, which are in each case related to a certain patient weight and are displayed on the display unit in combination with the respective patient weight.

The simulation of the movements of the operating table and the restrictions ascertained therefrom during subsequent operation of the operating table have the advantage that the operator is not required to ascertain the restrictions manually. Automatic calculation of the permissible ranges is less prone to errors. In contrast to a database containing all possible configurations of the operating table and their corresponding restrictions, the proposed solution has the advantage that the calculated limits are closer to the actual limits of the joints. Moreover, maintenance can be performed in a simpler and less time-consuming and error-prone manner. New accessories do not necessarily need to result in a software update in the proposed solution, as is the case with the database solution.

In some designs, in addition to the patient weight, one or more additional parameters can be used to ascertain the restrictions during operation of the operating table from these parameters. This is explained further below.

The evaluation unit can be, for example, a hardware processor or any other computer system or can be integrated into a hardware processor or into a computer system. In addition to the tasks of the evaluation unit, the hardware processor or the computer system can also perform other tasks. The evaluation unit can be arranged inside the operating table and in particular in the patient support device. However, the evaluation unit can also be located outside the operating table, in particular also outside the operating theatre. Since the simulation steps performed by the evaluation unit are computationally expensive, the evaluation unit can be located in a back-end or connection module. The evaluation unit can exchange data with the input unit and/or the display unit, for example, via one or more interfaces. The data transfer can in particular take place at least partially by radio and/or in a wired manner.

In some designs, the evaluation unit can control the individual components of the patient support device during operation of the operating table such that the restrictions are observed, e.g., the patient support device can be controlled such that the patient support device is trended, tilted, or displaced longitudinally or vertically only within the previously determined position limits. Alternatively, it can be envisaged that the restrictions generated by the evaluation unit serve only to inform the operator about the restricted possibilities before placing the patient on the patient support device. Alternatively, the restrictions or limit values could be used to produce alerts, alarms and/or automatic breaks or stops of the movement when the table movements reach or approach a calculated limit value. Moreover, the operator could be able to continue the movements beyond the calculated limit value. As soon as the patient has been placed on the patient support device, the load and the load centre can be determined via measurements, for example with the aid of load sensors. The measurement results can be used to determine the restrictions to which the operating table is subject during subsequent operation.

In some designs, the evaluation unit determines the restrictions during operation of the operating table not just from the weight information but additionally also based on an identification and/or configuration of the patient support device. The identification of the supporting surface regions can relate to various partial regions of the patient support device, which can be detachably or fixedly connected to one another. For example, a patient support device can comprise head, leg, arm, and intermediate regions, and other suitable partial regions. By means of the identification, it can be known which partial regions the patient support device comprises. The configuration can, for example, indicate in which configuration or order or location the individual partial regions are arranged. Each of the partial regions can have, for example, one or more supporting surface subsections which are connected to one another.

Operating tables can be extended with accessories to ensure optimal support of the patient and to be able to execute the procedure in a reliable manner. Accessories can be detachably fastened to an operating table for various purposes. For example, they can serve to support certain body parts, such as the head, a leg, or an arm. Yet, accessories may also have other functions, e.g., accessories may be instrument tables, limb positioning supports, or infusion holders that are fastened to the lateral rails of the patient support device. Supporting surface main sections and subsections can also be included among the accessories.

In some designs, a detection unit can be envisaged for detecting accessories attached to the operating table and in particular to the patient support device. For detecting the accessories, signals can be transmitted from the accessories to the detection unit. The signals can contain information on the respective accessories, which allows the detection unit to identify the respective accessory. The signals used for detecting the accessories can be, for example, electrical or optical signals or radio signals.

The detection unit can have a suitable receiving unit for receiving the signals from the accessories. Moreover, the detection unit can have a hardware processor or any other computer system or can be integrated into a hardware processor or into a computer system which enables identifying the accessories. The detection unit can be arranged inside the operating table and in particular in the patient support device or, alternatively, outside the operating table.

The detection unit can inform the evaluation unit about which accessories are attached to the operating table and in particular to the patient support device. In some designs, the evaluation unit can use this information in addition to the weight information and, as appropriate, further information to determine the restrictions during operation of the operating table by means of a simulation of the movements of the operating table.

In some designs, the input unit and/or the interface via which the patient weight information is received can be designed such that a planned position the patient is to adopt on the patient support device and/or a planned centre of gravity of the patient on the patient support device can be input to the input unit and/or received by the interface. For example, the input unit can comprise a touch screen, which graphically presents the operating table or the patient support device. The operator can move a graphical slider to the location where the centre of gravity of the patient should subsequently be located. It is also conceivable for the input unit to display various positions the patient can adopt on the patient support device on a touch screen and for the operator to select the applicable position.

In some designs, the evaluation unit can consider the planned position the patient is to adopt on the patient support device and/or the planned centre of gravity of the patient on the patient support device when ascertaining the restrictions during operation of the operating table.

In some designs, the restrictions can relate to the movability of the patient support device and in particular to the adjustability and extensibility of the segments of the patient support device and/or the adjustability and extensibility of the operating table column. Basically, the patient support device or a segment of the patient support device can be trended and/or tilted and/or longitudinally and/or laterally displaced and/or adjusted in height, in particular by means of the operating table column. A trend of the patient support device is also referred to as a Trendelenburg inclination where the patient is supported so that the head of the patient is down and the pelvis of the patient is further up. An anti-Trendelenburg inclination is where the head of the patient is supported at an elevated position while the pelvis is further down. A tilt means that the patient support device is inclined towards the side. A trend or tilt of the patient support device is about one or more joints. The restrictions may relate to the degree of trend and/or tilt and/or longitudinal and/or lateral displaceability. Depending on which supporting surface subsections are connected to the supporting surface main section, other restrictions may arise with respect to the adjustability and extensibility of the supporting surface subsections. The restrictions with respect to the movability of the patient support device can relate to the movement of the entire patient support device and/or to the separate movement of the supporting surface subsections or at least one segment of the patient support device and/or the movement of the operating table column.

In some designs, the restrictions during operation of the operating table can be characterised at least by regions within which the operating table, in particular the patient support device and/or at least one segment of the patient support device and/or the operating table column, are allowed to be moved. Such regions can be presented graphically on the display unit, for example. Moreover, position limits can also be presented on the display unit.

In some designs, the restrictions during operation of the operating table may comprise one or more of the following restrictions:
restrictions during selection of axes about which movement of the patient support device and/or of at least one segment of the patient support device is possible; for example, movement of the patient support device or of a supporting surface subsection is not allowed to be performed about certain axes;
restrictions on the region within which the patient support device and/or at least one segment of the patient support device is movable about an axis;
restrictions on the speed at which the patient support device and/or at least one segment of the patient support device is movable about an axis;
restrictions during trending the patient support device;
restrictions during tilting the patient support device;
restrictions during longitudinal displacement of the patient support device;
restrictions during lateral displacement of the patient support device;
restrictions during height adjustment of the patient support device, which can in particular be performed by the operating table column;
restrictions during extension of the rollers of the operating table; and/or
restrictions during motorised transport of the operating table.

In some designs, the evaluation unit determines the restrictions during operation of the operating table such that tipping of the operating table and/or overload of the operating table and/or of at least one component of the operating table are prevented. For example, the regions within which the patient support device or at least one segment of the patient support device and/or the operating table column can be adjusted can be restricted, or movements of the operating table and/or of the patient support device and/or of the operating table column can be blocked to avoid tipping or overload.

In some designs, the evaluation unit simulates several positions the operating table can adopt during a specified movement. The evaluation unit checks whether a restriction is required in the respective position, in particular whether a tipping risk of the operating table and/or an overload risk of the operating table and/or of at least one component of the operating table is present. The smaller the distance between adjacent positions examined by the evaluation unit, the finer the restrictions can be chosen to be. However, a small distance between adjacent positions also has the consequence that the computational burden for the simulations is thereby increased.

In some designs, the evaluation unit can determine, for several positions the operating table can adopt during a specified movement, a residual tipping torque related to a specified tipping point. Further, the evaluation unit can compare the determined residual tipping torque with a specified residual tipping torque threshold for each of the positions. If the residual tipping torque in one of the positions falls below the specified residual tipping torque threshold, the evaluation unit can establish a tipping risk for this position and can also stipulate that the operating table is not allowed to be moved to this position during subsequent operation of the operating table.

In some designs, the display unit can display information on at least one restriction during operation of the operating table if the evaluation unit has established a tipping risk for one or more positions of the operating table.

In some designs, the evaluation unit can determine the residual tipping torque from the total load and/or the centre of gravity of the total load. The residual tipping torque can further be related to a certain tipping point or to several tipping points.

The total load is the load which results from the entire operating table, the patient supported on the operating table, the accessories fastened to the operating table, and any other external forces.

A tipping point is a point or, as appropriate, an axis about which the operating table can tip. For example, a tipping point can be located on a lower lateral edge of the foot which faces the floor. Further, a tipping point can be characterised by a castor which can be used to displace the operating table on the floor.

In some designs, the tipping points can be defined as all points along the circumference of a table base or foot which faces (and in some cases touches) the floor underneath. For instance, all points along the circumference of a rectangular table base can be tipping points. In other designs, e.g., if the foot has a less regular shape, the tipping points can be defined as all points along the edges of a conceptual or imaginary polygon defined by the distant corners of a foot. In the case of an H-shaped base, the tipping points would be, for instance, the four corners of the H and the edges of a conceptual rectangle formed by the four corners of the H. With a round base, each point on the circumference would be a tipping point.

In general, it can be said that the operating table remains stable if the centre of gravity of the total load is above a surface delimited by the tipping points. However, if the centre of gravity of the total load is not directly above this surface, the operating table will tip.

The residual tipping torque at a tipping point can be determined by multiplying the distance of the tipping point from the centre of gravity of the total load by the total load, with the total load indicated as a force. This is referred to in the literature as the “residual tipping torque”. If the determined value for the residual tipping torque is positive, this means that the operating table is stable with respect to this tipping point. If the residual tipping torque is negative, the operating table will tip. The greater the value of the residual tipping torque, the more stable the operating table. In some designs, the residual tipping torque threshold is specified, which has a value of 225 Nm, for instance. This means that the residual tipping torque should not be less than 225 Nm. If the residual tipping torque falls below its threshold, the evaluation unit can stipulate that this position of the operating table should be blocked.

In some designs, the evaluation unit can determine, at each position or at a plurality of positions the operating table can adopt during a specified movement, for a plurality of tipping points, in particular for all possible tipping points, a respective residual tipping torque. The evaluation unit can compare each of these several residual tipping torques with the residual tipping torque threshold. If, in a certain position of the operating table, only one of the tipping torques falls below the residual tipping torque threshold, the evaluation unit can design the restrictions such that the relevant position is in the non-permissible range.

In some designs, at least one virtual or imaginary line can be specified. The at least one virtual line can, for example, pass through at least one tipping point and can moreover, for example, enclose a specified angle, referred to as a stability angle, with a specified normal vector. The evaluation unit can determine, for several positions the operating table can adopt during a specified movement, the position of a load centre of the operating table, for example the centre of gravity of the total load, with respect to the at least one specified virtual line. If the load centre of the operating table passes through the at least one virtual line in a position, the evaluation unit can establish a tipping risk for this position and exclude this position for subsequent operation of the operating table.

In particular, the evaluation unit can indicate a tipping risk if the centre of gravity of the total load passes through the at least one virtual line in a direction in which the residual tipping torque decreases. The virtual line can also be shifted in parallel and accordingly not pass through the tipping point. In this case, the centre of gravity of the total load must also be shifted accordingly to be able to indicate the tipping risk.

The normal vector can be defined, for example, by the vector of the weight of the operating table if the operating table is standing on a flat, non-inclined floor. Then, the normal vector is orientated perpendicularly to the floor surface. The normal vector can also be defined, for example, by the floor plate of the foot or the patient support device in the normal position. Then, the normal vector is orientated perpendicularly to the floor plate of the foot or perpendicularly to the patient support device in the normal position.

In some designs, for a plurality of tipping points, in particular for all possible tipping points, at least one virtual or imaginary line can be specified in each case, which passes through the respective tipping point and which encloses a specified angle, the stability angle, with the specified normal vector. The several virtual lines define a space. If the centre of gravity of the total load is within this space, there is no risk of the operating table tipping. Only when the centre of gravity of the total load exits the space defined or bounded by the virtual lines can the operating table tip. If the centre of gravity of the total load exits the space defined by the virtual lines, the evaluation unit can establish a tipping risk for this position and display to the operator that this position is to be excluded for subsequent operation of the operating table.

In some designs, the specified stability angle, which the virtual or imaginary line can enclose by means of a tipping point with the specified normal vector, can depend on the nature of the tipping point. For example, the stability angle can be larger if the tipping point is given by a castor. In comparison, the stability angle can be smaller if the tipping point does not include any castor but is located, for example, on a lower lateral edge of the foot.

In one design, a stability angle of 10 degrees can be chosen if the tipping point is given by a castor. For all remaining tipping points, in particular rigid bases or substructures, a stability angle of 5 degrees can be chosen.

In some designs, the stability angle is at least 2 degrees or at least 5 degrees, or is in the range of 5 to 15 degrees or in the range of 3 to 20 degrees. In some designs with retractable wheels or rollers, the stability angle is at least 2 degrees if the operating table is standing on the floor and at least 8 degrees if it is standing on wheels or rollers. Certain safety regulations demand that medical tables remain stable at a trend of 5 degrees if they are standing directly on the floor and at a trend of 10 degrees if they are standing on wheels. This technology is useful to meet such safety regulations but is not limited to this purpose.

The two designs described above, in which the residual tipping torque is compared with the residual tipping torque threshold, or it is checked whether the centre of gravity of the total load passes through the at least one virtual line, can be used independently of one another to produce the restrictions during operation of the operating table. Further, the two methods can also be combined with one another.

In some designs, the evaluation unit can determine, from the patient weight and/or the centre of gravity of the patient, whether there is an overload risk for the operating table and/or for at least one component of the operating table. In particular, the evaluation unit can determine, for several positions or even for all the positions the operating table can adopt during a specified movement, whether an overload risk is present. As described above, the patient centre of gravity can be input to the input unit by the operator, for example. If there is an overload risk, the display unit can make it clear to the operator by displaying the restrictions that the movement possibilities of the operating table and/or of the patient support device are correspondingly restricted and that the operating table should not or cannot adopt the positions subject to an overload risk during operation.

By observing corresponding restrictions, damage, for example bending or even breaking of a component of the operating table, due to an excessively high load acting on the operating table, can be prevented. Thereby, any danger to the patient is inhibited.

The at least one component of the operating table for which the overload risk is determined can be, for example, a supporting surface main section or subsection of the patient support device or another accessory or another component of the operating table, for instance, a castor or the operating table column.

In one design, the evaluation unit can compare a load acting on the operating table and/or on the patient support device, in particular the active load, with at least one specified overload threshold, and establish that there is an overload risk for the operating table and/or for at least one component of the operating table if the load exceeds the at least one overload threshold.

The at least one overload threshold can be specific to the operating table and/or the at least one component. Consequently, an individual overload threshold can be used for each component of the operating table. This enables determining the overload risk for components of different stabilities.

The evaluation unit can, for several positions or even for all the positions the operating table can adopt during a specified movement, compare the load acting on the operating table and/or on the patient support device with the at least one specified overload threshold. If there is an overload risk, the evaluation unit can correspondingly restrict the movement possibilities of the operating table and/or of the patient support device by suitably choosing the restrictions.

In addition to possible overload risks for individual supporting surface sections and a configuration of supporting surface subsections, overload risks for certain sections or regions of the patient support device can also be determined. The regions can extend, for example, along the outer boundaries of the supporting surface subsections. In this case, a region comprises a certain number of supporting surface subsections. However, it is also conceivable that a region boundary does not run along the outer boundaries of the supporting surface subsections. In this case, a part of a supporting surface subsection can belong to a region, while the remaining part of the supporting surface subsection belongs to the adjacent region. As such, in some designs, at least a part of the patient support device can be divided virtually or imaginarily into several regions, and an overload threshold can be specified for each region. The evaluation unit can verify, for several positions or even for all the positions the operating table can adopt during a specified movement, in which region the centre of gravity of a load acting on the operating table and/or on the patient support device is located, and can establish an overload risk if the load exceeds the overload threshold specified for this region. If there is an overload risk, the evaluation unit can choose the restrictions such that the restricted movement possibilities of the operating table and/or of the patient support device are displayed to the operator.

Moreover, a graph or a curve extending along at least one part of the patient support device can be specified. A respective overload threshold is specified by the graph or the curve at each location of the at least one part of the patient support device. The graph or curve can be a straight line, for example. In particular, the straight line can slope towards a distal end of the patient support device, so that the overload threshold becomes smaller towards the end of the patient support device. The evaluation unit can verify, for several positions or even for all the positions the operating table can adopt during a specified movement, at which location of the patient support device the centre of gravity of the defined load is located. However, this does not necessarily mean that the centre of gravity of the defined load is located within the patient support device. The centre of gravity can also be located outside the patient support device. In this case, the corresponding location of the patient support device can be ascertained, for example, by a vertical projection of the centre of gravity onto the patient support device. The evaluation unit can compare the defined load, in particular the active load, with the overload threshold specified for the ascertained location and, if the defined load exceeds the overload threshold specified for this location, can adapt the restrictions such that it is displayed to the operator that the operating table is not allowed to adopt the corresponding position during operation.

In some designs, the system can have at least one drive for moving the operating table. The evaluation unit can determine, from the patient weight and/or the centre of gravity of the patient, for several positions or even for all the positions the operating table can adopt during a specified movement, a load acting on the at least one drive, and can establish an overload risk if the load exceeds at least one specified overload threshold which is specific to the at least one drive. If there is an overload risk, the evaluation unit can correspondingly restrict the movement possibilities of the operating table and/or of the patient support device by suitably choosing the restrictions and can display this to the operator.

The drive can in particular be an electric drive which serves, for example, to adjust the patient support device or individual components of the patient support device, in particular to trend, tilt, displace or raise the patient support device. Moreover, the operating table can comprise several drives. For each of the drives, an individual overload threshold can be indicated, which is specific to the respective drive. Thereby, individual overload risks for the drives can be indicated.

According to a second aspect of the present disclosure, a method is provided which is adapted for determining and displaying restrictions during operation of an operating table. According to the method, information on the weight of a patient can be input to an input unit, and/or electronic patient weight information can be received at an interface from outside the system. Restrictions during operation of the operating table can be determined based on at least the patient weight. The restrictions can be displayed on a display unit before placing the patient on a patient support device, in particular a surgical patient support device. The patient support device can be envisaged for fastening to an operating table column of an operating table and can also be fastened to the operating table column.

In some designs, the restrictions during operation of the operating table can be determined based on at least the patient weight by simulating movements of the operating table with the patient supported thereon.

The method according to the second aspect can have all designs which are described in the present disclosure in connection with the system according to the first aspect.

The present disclosure also comprises circuits and/or electronic instructions for controlling operating tables and remote controls, displays and user interfaces for use with operating tables and for carrying out the methods and functions described in this disclosure, in particular electronics and software, which enable all that is described in the application.

### BRIEF DESCRIPTION OF THE DRAWINGS

Example embodiments of the present disclosure are explained in more detail hereinafter with reference to the figures. In the drawings:

FIG. 1 shows a schematic side view of an operating table with a patient positioned on a patient support device of the operating table;

FIG. 2 shows a schematic representation of the architecture of a system according to the disclosure for determining and displaying restrictions during operation of an operating table;

FIG. 3 shows a schematic representation of an operating table according to the disclosure for illustrating the measuring load, the active load, the total load, and the work load;

FIG. 4 shows a schematic representation of a flowchart for determining restrictions during operation of an operating table according to the disclosure;

FIGS. 5A and 5B show schematic representations of an operating table according to the disclosure in a locked and unlocked position, respectively, with tipping points;

FIGS. 6A and 6B show schematic representations of an operating table according to the disclosure with a centre of gravity of the total load inside and outside, respectively, the contact area of the tipping points;

FIG. 7 shows a schematic representation of an operating table according to the disclosure with virtual 5-degree and 10-degree lines;

FIG. 8 shows a schematic representation of an operating table according to the disclosure with the load capacity of individual components;

FIG. 9 shows a schematic representation of an operating table according to the disclosure with a configuration made of extension sections;

FIGS. 10A and 10B show schematic representations of an operating table according to the disclosure with load limits differing in sections or points; and

FIG. 11 shows a schematic representation of an operating table according to the disclosure in an extreme Trendelenburg position.

### DETAILED DESCRIPTION OF THE FIGURES

In the following description, example embodiments of the present disclosure are described with reference to the drawings. The drawings are not necessarily drawn to scale but are intended to only schematically illustrate the respective features.

It is to be noted that the features and components described below can each be combined with one another, irrespective of whether they were described in connection with a single embodiment. The combination of features in the respective embodiments only serves to illustrate the basic setup and the functioning of the claimed device.

In the figures, identical or similar elements are labelled with identical reference numerals as far as this is appropriate.

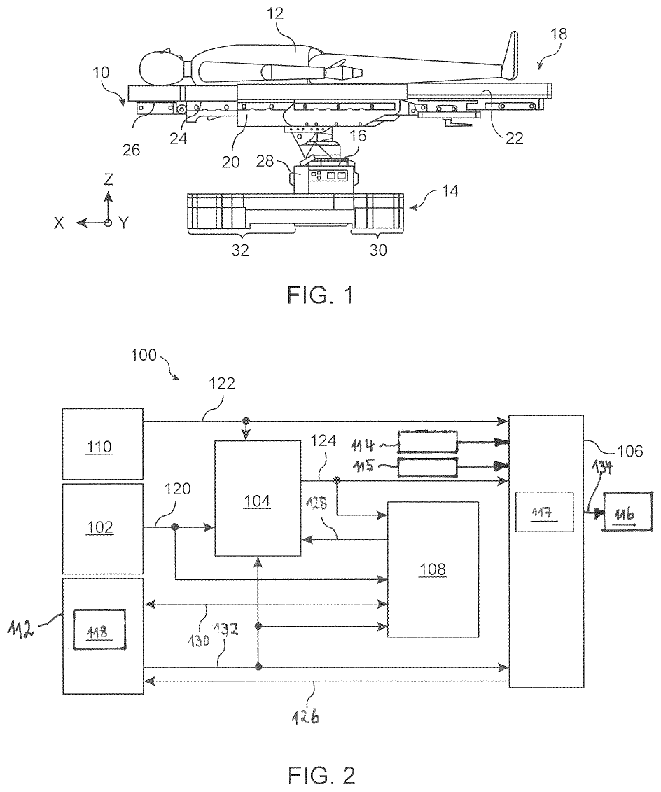

FIG. 1 schematically shows a mobile operating table 10 which can be used for supporting a patient 12 during a surgical procedure and for transporting them. The mobile operating table 10 comprises, from bottom to top, a foot 14 for placing the operating table 10 on underlying ground, an operating table column 16 comprising the foot 14 and being perpendicularly arranged, and a patient support device 18 fastened to an upper end of the operating table column 16. The patient support device 18 can be fixedly connected to the operating table column 16 or alternatively be detachably fastened to the operating table column 16.

The patient support device 18 is formed modularly and serves to support the patient 12. The patient support device 18 comprises a supporting surface main section 20 connected to the operating table column 16 which can be extended as desired by coupling miscellaneous supporting surface subsections thereto. In FIG. 1, a leg section 22, a shoulder section 24, and a head section 26 are coupled to the supporting surface main section 10 as supporting surface subsections.

Depending on the type of surgical procedure to be performed, the patient support device 18 of the operating table 10 can be brought to a suitable height and both tilted and trended.

The operating table column 16 is formed to be adjustable in height and has internal mechanics for adjusting the height of the patient support device 18 of the operating table 10. The mechanics are arranged in a housing 28 which protects the components from dirt.

The foot 14 has two sections 30, 32 of different lengths. The section 30 is a short section which is associated with a foot end of the leg section 22, i.e., the end of the patient support device 18 on which the feet of the patient 12 to be treated rest. The section 32 is a long section which is associated with the head section 26 of the patient support device 18.

Moreover, the foot 14 may feature wheels or rollers which can be used to move the operating table 10 on the floor. Alternatively, the foot 14 can be fixedly anchored to the floor.

For better illustration, a Cartesian coordinate system X-Y-Z is inserted in FIG. 1. The X-axis and the Y-axis are the horizontal axes, the Z-axis is the vertical axis. The X-axis extends along the supporting surface subsections 22, 24, 26 arranged next to one another.

FIG. 2 schematically shows the system architecture of a system 100 according to the disclosure for determining and displaying restrictions during operation of the operating table 10. The system 100 is a system according to the first aspect of the present disclosure and can be operated with a method according to the second aspect.

The system 100 can comprise the patient support device 18 represented in FIG. 1 and in particular further components of the operating table 10 or the entire operating table 10. Also, the system 100 has a load sensor arrangement 102, a load determining unit 104, a safety unit 106, a monitoring and calibration unit 108, a data storage 110, further components 112 of the operating table 10, an input unit 114, an interface 115 and a display unit 116. Further, the safety unit 106 contains an evaluation unit 117. One of the further components 112 of the operating table 10 is a detection unit 118.

The load sensor arrangement 102 contains several load sensors and is formed to measure at least one size from which a load acting on the load sensor arrangement 102 can be determined. In the present case, the load sensors are force sensors which respectively measure a force acting on the respective sensor. The force values measured by the individual force sensors are output by the load sensor arrangement 102 as a signal 120 in a digital form. Further, the load sensor arrangement 102 contains electronic components which are required for operation of the force sensors.

The load determining unit 104 receives the signal 120 with the measured force values and determines a desired load and/or a load centre therefrom. In detail, the load determining unit 104 can determine a measuring load, an active load, a work load, and/or a total load and the associated load centres. The load determining unit 104 can determine the desired load and/or the load centre during the entire operation of the operating table 10, i.e., the load determining unit 104 can already measure the values for the load and/or the load centre before placing the patient on the patient support device 18 and also after supporting the patient on the operating table 10. Further, the load determining unit 104 can determine the corresponding values when accessories are added to the operating table 10 or the operating table 10 is adjusted to position the patient for a surgical procedure.

To be able to adequately process and analyse the delivered force values, the load determining unit 104 needs some data relating to the geometry and the masses or weights of the operating table 10 and the accessories. This data is stored in the data storage 110 and is made available to the load determining unit 104 by means of a signal 122. From this data, information on the masses and centres of gravity of the individual components of the operating table 10 and the accessories can be extracted in particular. The data storage 110 is extendable via a connectivity module of the operating table 10.

The load determining unit 104 produces a signal 124 as an output signal which contains information on the determined loads and load centres. This information is transmitted to the safety unit 106, where all available data is analysed, including the loads, centres of gravity and the position data of the operating table 10 and the accessories recognised by the operating table 10.

The safety unit 106 decides whether the operating table 10 is safe or whether it is in a dangerous situation. The safety unit 106 produces a safety signal 126 which indicates whether the operating table 10 is in a safety-critical state. A safety-critical state may be present, for example, if there is a risk that the operating table 10 will tip or individual components of the operating table 10 will be overloaded.

Depending on the severity of the recognised situation, the algorithm reacts correspondingly. For instance, the operating table 10 may only output an alert or stop the movement. The alerts can be via an acoustic or optical signal through the operating table 10 or in the form of text via the remote control. The measures can vary from slowing down the movement speed to stopping the movement and even blocking some functions and last until a state is reached in which the operating table 10 is safe again.

It can be envisaged that the safety functions can be deactivated by the operator at all times and the movement of the operating table 10 can be continued at their own risk.

As the system is to recognise critical situations reliably, the system also features a monitoring and calibration unit 108. This software module checks the plausibility of the measured values and recognises whether the system is working incorrectly or whether calibration or taring of the system is required. The monitoring and calibration unit 108 produces corresponding output signals 128, 130, which are transmitted to the load determining unit 104 or the components 112 of the operating table 10.

The components 112 of the operating table 10 continuously generate position data, data for adjusting individual components and information on the accessories recognised by the operating table 10. This data is made available to the system using a signal 132.

Moreover, the system 100 is formed to give the operator, even before placing the patient on the patient support device 18, information regarding the restrictions to which the operating table 10 will likely be subject when the patient is on the operating table 10.

For the system 100 to be able to ascertain the restrictions without the patient being on the operating table 10, the system 100 must be given information on the weight of the patient. An operator can input this information to the input unit 114, which is integrated, for example, into a remote control which serves to control the operating table 10.

Further, the information on the weight of the patient can also be received electronically by the interface 115. The patient weight information can be stored, for example, in a database and can from there be communicated to the system 100 via the interface 115.

The patient weight information input to the input unit 114 by the operator or received by the interface 115 is supplied to the evaluation unit 117 integrated into the safety unit 106.

The evaluation unit 117 uses the patient weight information to determine restrictions to which the operating table 10 is subject during subsequent operation with the patient supported on the patient support device 18. The evaluation unit 117 determines the restrictions by the evaluation unit 117 simulating movements of the operating table 10 with the patient supported thereon. The evaluation unit 117 can ascertain the restrictions even before placing the patient on the patient support device 18.

The restrictions can be displayed on the display unit 116. For this purpose, the evaluation unit 117 communicates a signal 134, which contains the restrictions determined by the evaluation unit 117, to the display unit 116. The restrictions can be displayed on the display unit 116 before placing the patient on the patient support device 18. The information presented on the display unit 116 notifies the operator of the operating table 10 of the restrictions to which the operating table 10 is subject during the imminent procedure.

The display unit 116 can present the information on the restrictions to which the operating table 10 is subject during operation in the form of text and/or graphically. The display unit 116 is integrated into the remote control of the operating table 10, for example in the form of a display. Additionally, the display unit 116 may also feature a monitor which is set up in the operating theatre and always displays to the operator during operation which restrictions of the operating table 10 apply.

The evaluation unit 117 or a different unit of the safety unit 106 can control the individual components of the operating table 10 during operation of the operating table 10, in particular the patient support device 18 and the operating table column 16, such that the restrictions are observed. Movements of the operating table 10 which would go beyond the permissible ranges can be prevented, for example, and/or alerts can be produced which point out that permissible ranges are being exited.

In addition to the patient weight information, the evaluation unit 116 can use further information to ascertain the restrictions during operation of the operating table 10. This information includes information on the identity and/or configuration of the patient support device 18 and the accessories attached to the operating table 10.

The detection unit 118 is formed to establish which accessories are attached to the operating table 10 and in particular to the patient support device 18. For detecting the accessories, signals can be transmitted from the accessories to the detection unit 118. The signals can contain information on the respective accessories, which allows the detection unit 118 to identify the respective accessory. The signals used for detecting the accessories can be, for example, electrical or optical signals or radio signals. Thereby, the detection unit 118 can in particular establish which supporting surface sections are connected to one another in what order and which further accessories are attached to the operating table 10.

The detection unit 118 informs the evaluation unit 117 about which accessories are attached to the operating table 10 and in particular to the patient support device 18. Moreover, the evaluation unit 117 can read data relating to the geometry and the masses or weights and centres of gravity of the accessories from the data storage 110. The evaluation unit 117 uses this information in addition to the weight information to simulate the movements of the operating table 10 and to determine the restrictions during operation of the operating table 10 from the simulations.

In a few embodiments, at least one drive for moving at least one part of the patient support device 18 with respect to other parts of the system 100 and/or with respect to another part of the patient support device 18 may be envisaged.

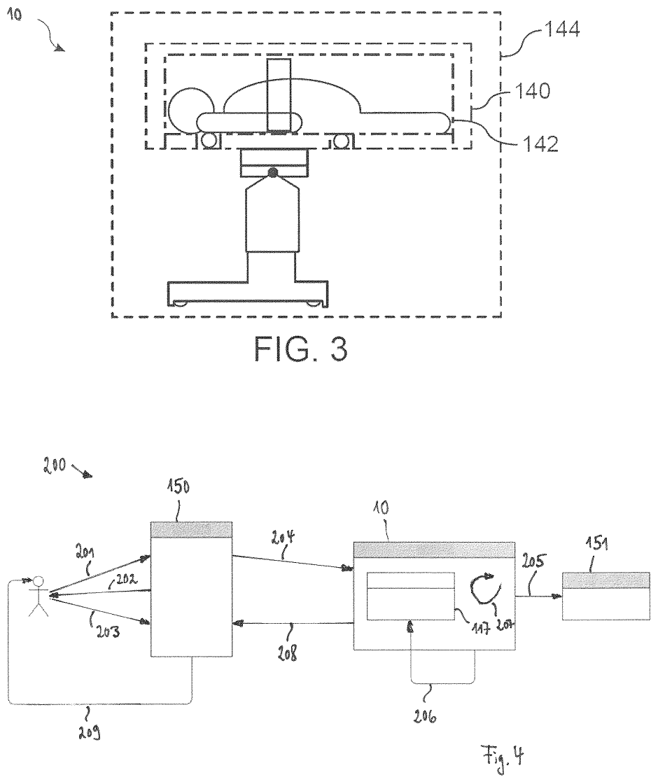

FIG. 3 schematically illustrates various loads the load determining unit 104 can determine from the data delivered by the load sensor unit 102. In particular, the load determining unit 104 can determine a measuring load, an active load, a total load, and a work load.

The measuring load, which is identified in FIG. 3 by the reference numeral 140, is the load which acts on the load sensor arrangement 102. The measuring load corresponds to the load which is produced by all persons, objects and forces on the operating table 10 above the load sensors. The measuring load corresponds to the load value which is measured by the load sensor arrangement 102 which may be arranged in the operating table column 16.

The active load 142 corresponds to the load which is caused by components which are not associated with the operating table 10 and persons and external forces and acts on the operating table 10. The active load does not consider the influence of the components associated with the operating table 10 and of any recognised accessories. Only the remaining components of the operating table 10 contribute to the active load, i.e., the components not associated with the operating table 10. These can be accessories, for example, which are not recognised by the operating table 10. Moreover, the patient located on the operating table 10 contributes to the active load. Also, all forces acting externally on the operating table 10, which are, for example, exerted on the operating table 10 by persons and/or objects outside the operating table 10, contribute to the active load. Essentially, the active load is the measuring load without the influence of the known objects such as tabletop parts, recognised accessories, etc.

The total load 144 is the load which results from the measuring load and from a load caused by components which are associated with the operating table 10 and are below the load sensor arrangement 102. Consequently, the total load considers loads from components which are located below the load sensor arrangement 102 and cannot be measured by the load sensor arrangement 102 and as such do not contribute to the measuring load. Consequently, the total load is the load which results from the entire operating table 10, the patient, the components associated with the operating table 10, the components not associated with the operating table 10, and any other external forces.

Moreover, a work load can be defined which is composed of the patient weight and the weight of the accessories used. The weight of the patient support device 18, which is composed of individual accessories, can be contained in the work load.

FIG. 4 shows a flowchart 200 which represents various steps for determining and displaying the restrictions which apply during operation of the operating table 10. The steps described hereinafter may be performed before placing the patient on the patient support device 18.

In a step 201, the operator induces the performance of the method for determining and displaying the restrictions by the operator actuating the corresponding input key of a remote control 150.

In a step 202, the operator is prompted by a corresponding representation on the display of the remote control 150 to input the weight of the patient to be supported on the patient support device 18 to the remote control 150.

In a step 203, the operator inputs the patient weight to the remote control 150. Further, it can be envisaged that the operator inputs the centre of gravity or the approximate decubitus position which the patient will later adopt on the operating table 10 to the remote control 150.

In a step 204, the remote control 150 communicates the patient weight and, as appropriate, the centre of gravity or the decubitus position of the patient to the evaluation unit 117. Further, the remote control 150 induces the evaluation unit 117 to perform a preliminary check of the operating table 10 and to determine the restrictions applicable during operation of the operating table 10.

In a step 205, the detection unit 118 establishes which accessories 151 are attached to the operating table 10. This information is communicated to the evaluation unit 117. Further, the evaluation unit 117 can extract further information on the accessories 151, in particular their masses and/or centres of gravity, from the data storage 110.

In a step 206, the evaluation unit 117 simulates movements of the operating table 10, wherein the patient weight input to the remote control 150 by the operator and the accessories 151 detected by the detection unit 118 and, if appropriate, the centre of gravity or the decubitus position of the patient are considered. In particular, it can be checked during the simulation whether in one or more certain positions the operating table 10 can adopt during operation, a tipping risk or an overload risk exceeds a respective specified threshold. For each joint about which a movement can be executed, a movement is simulated, and it is checked in which region of the joint a movement is not permissible, since this could, for example, cause an increased tipping risk or overload of at least one component of the operating table 10 due to the patient weight and/or the centre of gravity or the decubitus position of the patient. Moreover, it can be checked how far the patient support device 18 can be displaced longitudinally or laterally without the tipping risk or the overload risk exceeding the respective specified threshold. In a similar manner, all possible movements of the operating table 10 and/or of the patient support device 18 can be checked computationally. Regions with an increased tipping and/or overload risk can be excluded by ascertaining lower and upper limits for each joint. The restrictions during operation of the operating table 10 are thereby stipulated.

The simulation of the movements of the joints and other components of the operating table 10 in step 206 can consist of individual steps. Each step can relate to a certain position of the operating table 10, i.e., a certain position of the joints. In each position, it can be checked computationally whether the tipping risk or the overload risk exceeds the respective specified threshold. Thereafter, a further position of the operating table 10 is verified. The method is performed iteratively. Consequently, step 206 consists of a variety of individual steps performed iteratively. In FIG. 4, the iterative performance of the simulation is identified by the reference numeral 207.

In step 208, the evaluation unit 117 communicates the restrictions to the remote control 150.

In step 209, the remote control 150 presents the restrictions to the operator on the display of the remote control 150.

Hereinafter, example algorithms are described which are utilised by the evaluation unit 117 to simulate the movements of the operating table 10 and to establish in which positions there is an increased tipping and/or overload risk.

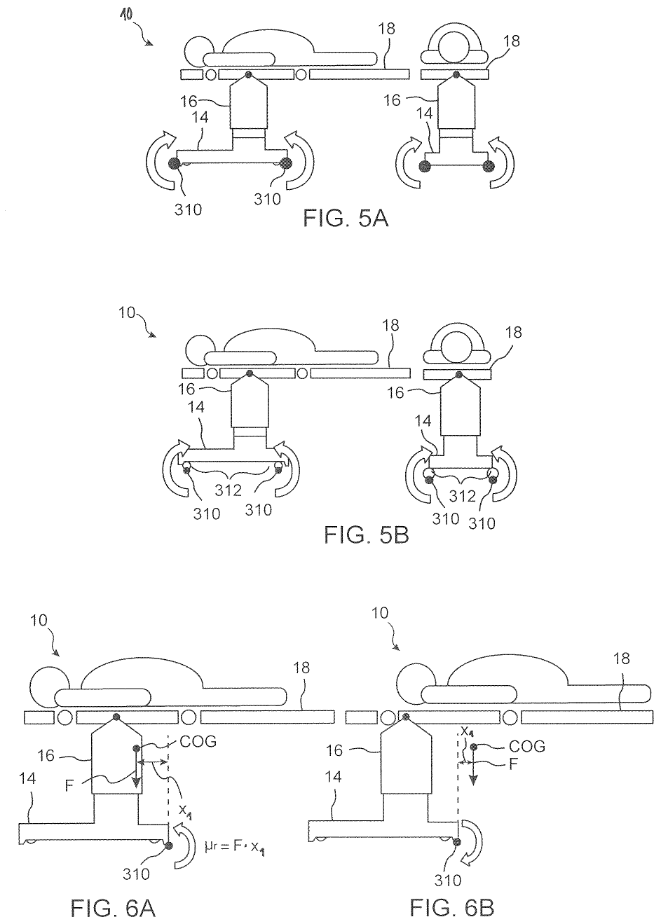

FIGS. 5A and 5B show the operating table 10 from the side and from the front, respectively. In FIG. 5A, the operating table 10 is in the lowered or locked position, i.e., the foot 14 is standing on the floor, so that the operating table 10 cannot be moved. In this position, the lower lateral edges of the foot 14, which face the floor, represent tipping points 310 about which the operating table 10 can tip.

In FIG. 5B, the operating table 10 is in the unlocked position, i.e., the operating table 10 is standing on castors 312 and can be moved on the floor. In this position, possible tipping points 310 are given by the castors 312.

Basically, the operating table 10 is stable as long as the centre of gravity COG of the total load lies within the contact surface of the tipping points 310, i.e., directly above a surface delimited by the tipping points 310. This situation is shown in an illustrative manner in FIG. 6A. However, if the centre of gravity COG of the total load is not directly above the contact surface of the tipping points 310, as shown in FIG. 6B, the operating table 10 could tip.

During the simulation, the evaluation unit 117 can ascertain a residual tipping torque Mᵣ for a certain position of the operating table 10 at a tipping point 310 by multiplying the distance x₁ between the tipping point 310 and the centre of gravity COG of the total load by the total load. The total load and the centre of gravity COG of the total load are calculated by the evaluation unit 117 from the patient weight input to the remote control 150 by the operator and the masses and centres of gravity of the detected accessories 151 and the remaining components of the operating table 10 and, if appropriate, the centre of gravity or the decubitus position of the patient. In FIGS. 6A and 6B, a force vector F is drawn as the total load and further the distance x₁ is drawn between the force vector F and the tipping point 310. The residual tipping torque Mᵣ is Mᵣ=F*x₁. A positive value for the residual tipping torque Mᵣ means that the operating table 10 is stable with respect to this tipping point 310 (cf. FIG. 6A). As the distance x₁ becomes smaller, the residual tipping torque Mᵣ likewise becomes smaller and the operating table 10 becomes less stable. If the residual tipping torque Mᵣ is negative, which means that the centre of gravity COG and the force vector F are not directly above the surface delimited by the tipping points 310, the operating table 10 will tip (cf. FIG. 6B). The greater the value of the residual tipping torque Mᵣ, the more stable the operating table 10. A residual tipping torque threshold is specified, which has a value of 225 Nm, for instance. This means that the residual tipping torque should not be less than 225 Nm. If the residual tipping torque falls below its threshold, the operating table 10 should not be moved to this position. The evaluation unit 117 stipulates the restrictions such that positions of the operating table 10 with a tipping risk are not within the permissible range for operation of the operating table 10.

Moreover, the evaluation unit 117 can ascertain a respective residual tipping torque for all possible tipping points and can compare each of these residual tipping torques with the residual tipping torque threshold. If, for a position of the operating table 10, only one of the tipping torques falls below the residual tipping torque threshold, the evaluation unit 117 can establish that there is an increased tipping risk in this position of the operating table 10 and the operating table 10 is not allowed to adopt this position during operation.

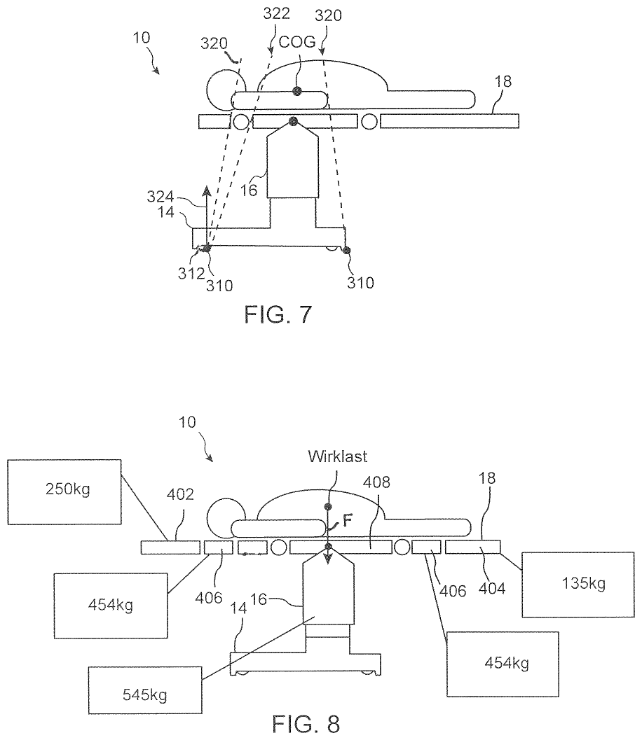

A further design for ascertaining the tipping risk is based on the stability requirements of the 60601-1 standard. The 60601-1 standard dictates that the operating table 10 must remain stable at a trend of 5 degrees under all circumstances of the intended use and that it must remain stable at a trend of 10 degrees only for the defined transport position. This requirement can be converted into a virtual 5-degree line 320 at each tipping point and into a 10-degree line 322 at each tipping point with a castor 312, as represented in FIG. 7. The angles of 5 and 10 degrees can be referred to as stability angles. Therefore, in some designs, there is a first stability angle if the operating table 10 is standing directly on the floor, and a second, larger stability angle if the operating table 10 is in a transport position on rollers or wheels.

The stability angles (of, for example, 5 or 10 degrees) are ascertained by means of a specified normal vector 324. The normal vector 324 can be defined, for example, by the floor plate of the foot 14 or the patient support device 18 in the normal position, i.e., in the non-extended position. The normal vector 324 is orientated perpendicularly to the floor plate of the foot 14 or perpendicularly to the patient support device 18 in the normal position. Instead of the 5-degree or 10-degree stability angle with the normal vector 324, other suitable stability angles can also be chosen for the virtual lines 320, 322.

If, in a simulated position of the operating table 10, the centre of gravity COG of the total load violates one of the virtual 5-degree lines 320, i.e., passes through it, the evaluation unit 117 stipulates that the operating table 10 is not allowed to adopt this position during operation. If one of the virtual 10-degree lines 322 is exceeded by the centre of gravity COG, the evaluation unit 117 can block the motorised transport function of the operating table 10 in this position.

A three-dimensional space is each defined by the virtual 5-degree lines 320 and the virtual 10-degree lines 322. Typically, the “walls” of the three-dimensional space are inclined inward as you move further upward from the base of the operating table 10, so that the centre of gravity COG is more restricted laterally at a higher centre of gravity COG than at a lower centre of gravity COG located closer to the floor. The inward inclination of the “walls” of the three-dimensional space is determined by the stability angle. In one design, the evaluation unit 117 can establish a tipping risk if the centre of gravity COG of the total load exits one of the defined spaces.

Accessories are ordinarily approved for use for a patient weight, in particular a maximum one. The evaluation unit 117 checks as part of the simulation whether the predicted weight does not exceed the weight limit for the accessories. If the weight limit of the operating table 10 or of the accessories is exceeded in a simulation, the evaluation unit 117 can include the corresponding position of the operating table 10 in the restrictions.

The operating table 10 represented in FIG. 8 has, as accessories, a head section 402, a leg section 404, and several extension sections 406 which are connected to a supporting surface main section 408 in the represented configuration. For each of the accessories, a maximum load capacity is indicated in FIG. 8. The head section 402 has a maximum load capacity of 250 kg, the leg section 404 has a maximum load capacity of 135 kg, each of the extension sections 406 has a maximum load capacity of 454 kg, and the entire operating table 10 has a maximum load capacity of 545 kg. The evaluation unit 117 checks whether one of the components is being overloaded.

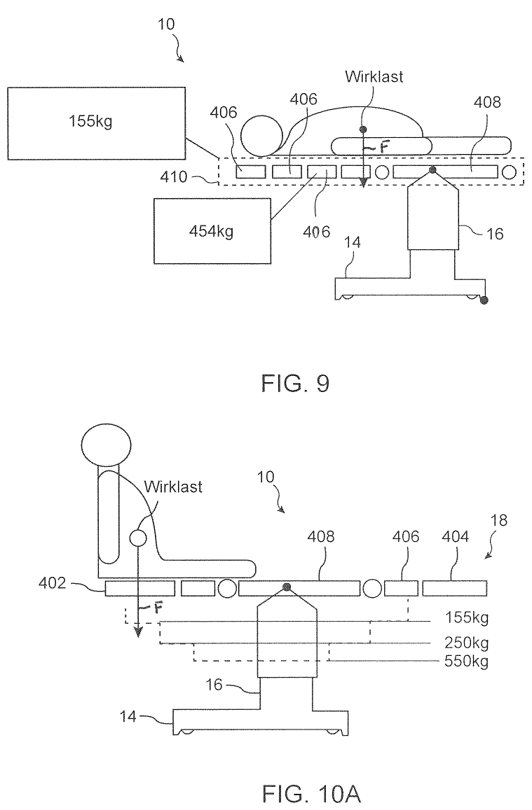

The accessories may be also overloaded if the configuration in which the accessories are connected to one another is not suitable for the load acting thereupon. For instance, as shown in FIG. 9, three extension sections 406 can be cascaded consecutively. Although each of the extension sections 406 is individually suitable for a load of 454 kg, a combination 410 of three extension sections 406 is only suitable for 155 kg. Therefore, in some designs, the permissible weight for the table configuration is determined considering a variety of extension sections 406 connected to the operating table, wherein the addition of further extension sections 406 reduces the permissible weight for the table configuration as a whole compared to configurations with fewer extension sections 406.

The evaluation unit 117 checks in which positions of the operating table 10 the predicted active load exceeds the permissible weight for the configuration 410 by simulating the positions of the operating table 10. If the permissible weight is exceeded in one or more of the positions, the evaluation unit 117 can add the corresponding positions of the operating table 10 to the restrictions.

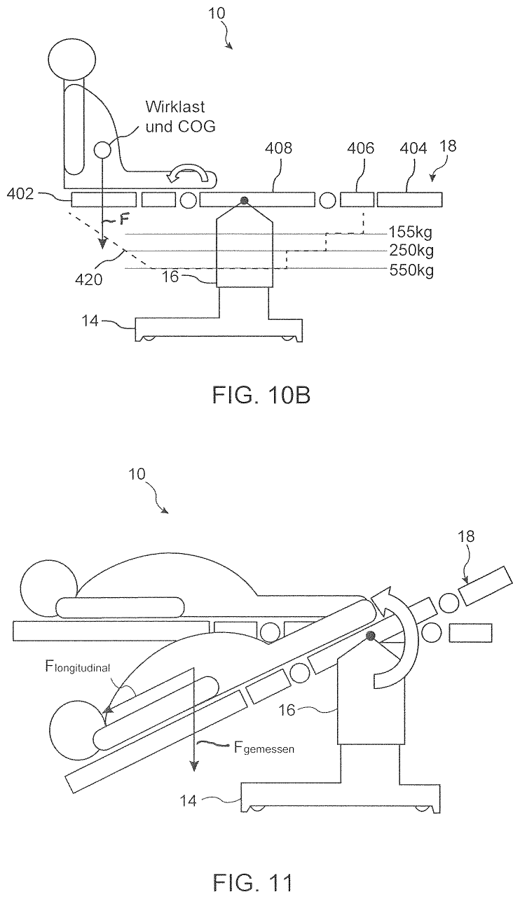

It is also conceivable that an overload situation is caused by a certain positioning of the patient. For example, FIG. 10A shows the case that the patient is seated on the head section 402 and the centre of gravity of the entire patient lies above the head section 402. Although the accessory 402 is suitable for the use of patients weighing 380 kg, the accessory 402 is only envisaged as a headrest, i.e., sitting on it is not allowed. To avoid the patient adopting such a position, it can be displayed to the operator on the display of the remote control that the patient is not allowed to adopt certain positions on the patient support device 18.

It is also possible for the operator to input a certain patient position to the remote control which the patient will adopt on the patient support device 18 during the procedure. The evaluation unit 117 considers the patient position when ascertaining the active load and/or the centre of gravity of the active load.

Moreover, the evaluation unit 117 can also determine overload risks for certain sections or regions of the patient support device 18. In FIG. 10A, as an example, the patient support device 18 is divided into different regions for which maximum load capacities of 155 kg, 250 kg and 550 kg apply, respectively. The evaluation unit 117 verifies in which region the predicted centre of gravity of the active load is located and compares the active load with the overload threshold, i.e., the maximum load capacity, specified for this region. If the active load exceeds the maximum load capacity specified for this region, the evaluation unit 117 can include the corresponding position of the operating table 10 in the restrictions.

FIG. 10B shows an alternative design compared to FIG. 10A. In the embodiment represented in FIG. 10B, the front part of the patient support device 18 comprising the head section 402 is not divided into various regions with a constant overload threshold in each case, instead, a straight line 420 is specified which extends along the front part of the patient support device 18. The straight line 420 specifies a respective overload threshold for each location of the front part of the patient support device 18. The overload threshold becomes smaller towards the head end of the patient support device 18. The straight line 420 is defined by F/M_{threshold}, where F is the force at the centre of gravity COG of the active load and M_{threshold} is a constant.

The evaluation unit 117 checks at which location of the patient support device 18 the centre of gravity of the active load is located and compares the active load with the overload threshold specified for this ascertained location. If the active load exceeds the maximum load capacity specified for this region, the evaluation unit 117 can modify the restrictions displayed to the operator such that the operating table 10 is not allowed to be moved to the corresponding position.

A further overload situation is present when drives of the operating table 10 are overloaded and the operating table 10 cannot move back to its original position. As an example, FIG. 11 shows an extreme longitudinal displacement and Trendelenburg position in combination with a heavy patient. This can be a position from which the operating table 10 cannot return to its starting position because the drives for longitudinal displacement and the Trendelenburg drives are overloaded. In particular, the Trendelenburg drives cannot apply the torque produced by the force F_{measured}. Besides, the drives for longitudinal displacement cannot produce the longitudinal force F_{longitudinal}.

The evaluation unit 117 can ascertain the load of each drive from the measuring load and/or the centre of gravity of the measuring load. For each drive, there is a load limit that should not be exceeded. When this limit is exceeded, it is displayed to the operator on the remote control 150 that the operating table 10 is not allowed to adopt the corresponding position.

Example embodiments and variants in accordance with the present disclosure are described in the following list of clauses and options:

Clause 1: A system (100) for determining and displaying restrictions during operation of an operating table (10), wherein the system (100) comprises:
a patient support device (18), in particular a surgical patient support device (18), for fastening to an operating table column (16) of an operating table (10),
a display unit (116) for displaying information on restrictions during operation of the operating table (10),
an input unit (114) for inputting information on the weight of a patient and/or an interface (115) for receiving electronic patient weight information from outside the system (100), and
an evaluation unit (117) formed to determine restrictions during operation of the operating table (10) based on at least the patient weight, and to display the restrictions on the display unit (116) before placing the patient on the patient support device (18).

Clause 2: The system (100) according to clause 1, wherein the evaluation unit (117) further determines the restrictions during operation of the operating table (10) based on an identification and/or configuration of the patient support device (18).

Clause 3: The system (100) according to clause 1 or 2, further comprising a detection unit (118) for detecting accessories attached to the operating table (10) and in particular to the patient support device (18).

Clause 4: The system (100) according to any one of the preceding clauses, wherein the evaluation unit (117) further determines the restrictions during operation of the operating table (10) based on accessories (151) attached to the operating table (10) and in particular to the patient support device (18).

Clause 5: The system (100) according to any one of the preceding clauses, wherein the input unit (114) and/or the interface (115) are designed such that a planned position the patient is to adopt on the patient support device (18) and/or a planned centre of gravity of the patient on the patient support device (18) can be input to the input unit (114) and/or received by the interface (115).

Clause 6: The system (100) according to any one of the preceding clauses, wherein the evaluation unit (117) further determines the restrictions during operation of the operating table (10) based on a planned position the patient is to adopt on the patient support device (18) and/or a planned centre of gravity of the patient on the patient support device (18).

Clause 7: The system (100) according to any one of the preceding clauses, wherein the display unit (116) is envisaged in a remote control (150) or a screen that is physically separated from the patient support device (18), and/or wherein the input unit (114) is envisaged in a remote control (150).

Clause 8: The system (100) according to any one of the preceding clauses, wherein the restrictions during operation of the operating table (10) relate to the movement of the patient support device (18), in particular the movement of the entire patient support device (18) and/or the separate movement of at least one segment of the patient support device (18), and/or the movement of the operating table column (16).

Clause 9: The system (100) according to any one of clauses 1 to 7, wherein the restrictions during operation of the operating table (10) relate to the separate movement of at least one segment of the patient support device (18) and/or the movement of the operating table column (16).

Clause 10: The system (100) according to any one of the preceding clauses, wherein the restrictions during operation of the operating table (10) are characterised at least by regions within which the operating table (10), in particular the patient support device (18) and/or at least one segment of the patient support device (18), are allowed to be moved.

Clause 11: The system (100) according to any one of the preceding clauses, wherein the restrictions during operation of the operating table (10) comprise one or more of the following restrictions: restrictions during selection of axes about which movement of the patient support device (18) and/or of at least one segment of the patient support device (18) is possible, restrictions on the region within which the patient support device (18) and/or at least one segment of the patient support device (18) is movable about an axis, restrictions on the speed at which the patient support device (18) and/or at least one segment of the patient support device (18) is movable about an axis, restrictions during trending the patient support device (18), restrictions during tilting the patient support device (18), restrictions during longitudinal displacement of the patient support device (18), restrictions during lateral displacement of the patient support device (18), restrictions during height adjustment of the patient support device (18), restrictions during extension of the rollers of the operating table (10), and/or restrictions during motorised transport of the operating table (10).

Clause 12: The system (100) according to any one of the preceding clauses, wherein the evaluation unit determines (117) the restrictions during operation of the operating table (10) such that tipping of the operating table (10) and/or overload of the operating table (10) and/or of at least one component of the operating table (10) are prevented.

Clause 13: The system (100) according to clause 12, wherein the overload of the operating table (10) and/or of at least one component of the operating table (10) comprises at least one of the following overloads:
overload of structural parts of the accessories attached to the operating table (10) and in particular to the patient support device (18), and/or of the operating table (10), wherein the overload may result in the structural parts bending or breaking; and
overload of motorised joints of the operating table (10) which cannot be moved or can only be moved to a limited extent due to the overload.

Clause 14: The system (100) according to any one of the preceding clauses, wherein the evaluation unit (117) determines, for several positions the operating table (10) can adopt during a specified movement, whether a restriction is required in the respective position, in particular whether there is a tipping risk of the operating table (10) and/or an overload risk of the operating table (10) and/or of at least one component of the operating table (10).

Clause 15: The system (100) according to any one of the preceding clauses, wherein the evaluation unit (117) determines, for several positions the operating table (10) can adopt during a specified movement, a residual tipping torque related to a specified tipping point, and the evaluation unit (117) establishes a tipping risk for one of the positions if the residual tipping torque in this position falls below a specified residual tipping torque threshold, wherein in particular, the display unit (116) displays information on at least one restriction during operation of the operating table (10) in response to determining a tipping risk for one or more of the several positions of the operating table (10).

Clause 16: The system (100) according to any one of the preceding clauses, wherein the evaluation unit (117) determines, for several positions the operating table (10) can adopt during a specified movement, the position of a load centre of the operating table (10) with respect to at least one specified virtual line, and the evaluation unit (117) establishes a tipping risk for one of the positions if the load centre of the operating table (10) passes through the at least one virtual line in this position, wherein in particular, the display unit (116) displays information on at least one restriction during operation of the operating table (10) in response to determining a tipping risk for one or more of the several positions of the operating table (10).

Clause 17: The system (100) according to any one of the preceding clauses, wherein the evaluation unit (117) determines, from the patient weight and/or the centre of gravity of the patient, whether there is an overload risk for the operating table (10) and/or for at least one component of the operating table (10).

Clause 18: The system (100) according to any one of the preceding clauses, wherein the evaluation unit (117) compares a load acting on the operating table (10) and/or on the patient support device (18) with at least one specified overload threshold, and establishes that there is an overload risk for the operating table (10) and/or for at least one component of the operating table (10) if the load exceeds the at least one overload threshold, wherein the at least one overload threshold is specific to the operating table (10) and/or the at least one component.

Clause 19: The system (100) according to any one of the preceding clauses, wherein at least part of the patient support device (18) is divided virtually into several regions, and an overload threshold is specified for each region, and wherein the evaluation unit (117) verifies in which region the centre of gravity of a load acting on the operating table (10) and/or on the patient support device (18) is located, and establishes an overload risk if the load exceeds the overload threshold specified for this region, wherein in particular, the display unit (116) displays information on at least one restriction during operation of the operating table (10) in response to determining an overload risk.

Clause 20: The system (100) according to any one of the preceding clauses, further comprising at least one drive for moving the operating table (10), wherein the evaluation unit (117) determines, from the patient weight and/or the centre of gravity of the patient, a load acting on the at least one drive, and establishes an overload risk if the load exceeds at least one specified overload threshold which is specific to the at least one drive, wherein in particular, the display unit (116) displays information on at least one restriction during operation of the operating table (10) in response to determining an overload risk.

Clause 21: The system (100) according to any one of the preceding clauses, wherein the patient weight information is input to the input unit (114) or is received from the interface (115) before placing the patient on the patient support device (18), and
wherein the evaluation unit (117) simulates the movements of the operating table (10) with the patient supported thereon before placing the patient on the patient support device (18).

Clause 22: The system (100) according to any one of the preceding clauses, wherein the evaluation unit (117) is formed to determine the restrictions during operation of the operating table (10) based on at least the patient weight by the evaluation unit (117) simulating movements of the operating table (10) with the patient supported thereon.

Clause 23: A method for determining and displaying restrictions during operation of an operating table (10), wherein
information on the weight of a patient is input to an input unit (114), and/or electronic patient weight information is received at an interface (115);
restrictions during operation of the operating table (10) are determined based on at least the patient weight; and
the restrictions are displayed on a display unit (116) before placing the patient on a patient support device (18), in particular a surgical patient support device (18).

1. A system (100) for determining and displaying restrictions during operation of an operating table (10), wherein the system (100) comprises:
a patient support device (18), in particular a surgical patient support device (18), for fastening to an operating table column (16) of an operating table (10), a display unit (116) for displaying information on restrictions during operation of the operating table (10),
an input unit (114) for inputting information on the weight of a patient and/or an interface (115) for receiving electronic patient weight information from outside the system (100), and
an evaluation unit (117) formed to determine restrictions during operation of the operating table (10) based on at least the patient weight, and to display the restrictions on the display unit (116) before placing the patient on the patient support device (18).

2. The system (100) according to claim 1, wherein the evaluation unit (117) further determines the restrictions during operation of the operating table (10) based on an identification and/or configuration of the patient support device (18).

3. The system (100) according to claim 1 or 2, further comprising a detection unit (118) for detecting accessories attached to the operating table (10) and in particular to the patient support device (18).

4. The system (100) according to any one of the preceding claims, wherein the evaluation unit (117) further determines the restrictions during operation of the operating table (10) based on accessories (151) attached to the operating table (10) and in particular to the patient support device (18).

5. The system (100) according to any one of the preceding claims, wherein the input unit (114) and/or the interface (115) are designed such that a planned position the patient is to adopt on the patient support device (18) and/or a planned centre of gravity of the patient on the patient support device (18) can be input to the input unit (114) and/or received by the interface (115).

6. The system (100) according to any one of the preceding claims, wherein the evaluation unit (117) further determines the restrictions during operation of the operating table (10) based on a planned position the patient is to adopt on the patient support device (18) and/or a planned centre of gravity of the patient on the patient support device (18).

7. The system (100) according to any one of the preceding claims, wherein the display unit (116) is envisaged in a remote control (150) or a screen that is physically separated from the patient support device (18), and/or wherein the input unit (114) is envisaged in a remote control (150).

8. The system (100) according to any one of the preceding claims, wherein the restrictions during operation of the operating table (10) relate to the movement of the patient support device (18), in particular the movement of the entire patient support device (18) and/or the separate movement of at least one segment of the patient support device (18), and/or the movement of the operating table column (16).

9. The system (100) according to any one of claims 1 to 7, wherein the restrictions during operation of the operating table (10) relate to the separate movement of at least one segment of the patient support device (18) and/or the movement of the operating table column (16).

10. The system (100) according to any one of the preceding claims, wherein the restrictions during operation of the operating table (10) are characterised at least by regions within which the operating table (10), in particular the patient support device (18) and/or at least one segment of the patient support device (18), are allowed to be moved.

11. The system (100) according to any one of the preceding claims, wherein the restrictions during operation of the operating table (10) comprise one or more of the following restrictions: restrictions during selection of axes about which movement of the patient support device (18) and/or of at least one segment of the patient support device (18) is possible, restrictions on the region within which the patient support device (18) and/or at least one segment of the patient support device (18) is movable about an axis, restrictions on the speed at which the patient support device (18) and/or at least one segment of the patient support device (18) is movable about an axis, restrictions during trending the patient support device (18), restrictions during tilting the patient support device (18), restrictions during longitudinal displacement of the patient support device (18), restrictions during lateral displacement of the patient support device (18), restrictions during height adjustment of the patient support device (18), restrictions during extension of the rollers of the operating table (10), and/or restrictions during motorised transport of the operating table (10).

12. The system (100) according to any one of the preceding claims, wherein the evaluation unit determines (117) the restrictions during operation of the operating table (10) such that tipping of the operating table (10) and/or overload of the operating table (10) and/or of at least one component of the operating table (10) are prevented.

13. The system (100) according to claim 12, wherein the overload of the operating table (10) and/or of at least one component of the operating table (10) comprises at least one of the following overloads:
overload of structural parts of the accessories attached to the operating table (10) and in particular to the patient support device (18), and/or of the operating table (10), wherein the overload may result in the structural parts bending or breaking; and
overload of motorised joints of the operating table (10) which cannot be moved or can only be moved to a limited extent due to the overload.

14. The system (100) according to any one of the preceding claims, wherein the evaluation unit (117) determines, for several positions the operating table (10) can adopt during a specified movement, whether a restriction is required in the respective position, in particular whether there is a tipping risk of the operating table (10) and/or an overload risk of the operating table (10) and/or of at least one component of the operating table (10).

15. The system (100) according to any one of the preceding claims, wherein the evaluation unit (117) determines, for several positions the operating table (10) can adopt during a specified movement, a residual tipping torque related to a specified tipping point, and the evaluation unit (117) establishes a tipping risk for one of the positions if the residual tipping torque in this position falls below a specified residual tipping torque threshold, wherein in particular, the display unit (116) displays information on at least one restriction during operation of the operating table (10) in response to determining a tipping risk for one or more of the several positions of the operating table (10).

16. The system (100) according to any one of the preceding claims, wherein the evaluation unit (117) determines, for several positions the operating table (10) can adopt during a specified movement, the position of a load centre of the operating table (10) with respect to at least one specified virtual line, and the evaluation unit (117) establishes a tipping risk for one of the positions if the load centre of the operating table (10) passes through the at least one virtual line in this position, wherein in particular, the display unit (116) displays information on at least one restriction during operation of the operating table (10) in response to determining a tipping risk for one or more of the several positions of the operating table (10).

17. The system (100) according to any one of the preceding claims, wherein the evaluation unit (117) determines, from the patient weight and/or the centre of gravity of the patient, whether there is an overload risk for the operating table (10) and/or for at least one component of the operating table (10).

18. The system (100) according to any one of the preceding claims, wherein the evaluation unit (117) compares a load acting on the operating table (10) and/or on the patient support device (18) with at least one specified overload threshold, and establishes that there is an overload risk for the operating table (10) and/or for at least one component of the operating table (10) if the load exceeds the at least one overload threshold, wherein the at least one overload threshold is specific to the operating table (10) and/or the at least one component.

19. The system (100) according to any one of the preceding claims, wherein at least part of the patient support device (18) is divided virtually into several regions, and an overload threshold is specified for each region, and
wherein the evaluation unit (117) verifies in which region the centre of gravity of a load acting on the operating table (10) and/or on the patient support device (18) is located, and establishes an overload risk if the load exceeds the overload threshold specified for this region, wherein in particular, the display unit (116) displays information on at least one restriction during operation of the operating table (10) in response to determining an overload risk.

20. The system (100) according to any one of the preceding claims, further comprising at least one drive for moving the operating table (10), in particular for moving at least one part of the patient support device (18) with respect to other parts of the system (100), further in particular for moving at least one part of the patient support device (18) with respect to another part of the patient support device (18), wherein the evaluation unit (117) determines, from the patient weight and/or the centre of gravity of the patient, a load acting on the at least one drive, and establishes an overload risk if the load exceeds at least one specified overload threshold which is specific to the at least one drive, wherein in particular, the display unit (116) displays information on at least one restriction during operation of the operating table (10) in response to determining an overload risk.

21. The system (100) according to any one of the preceding claims, wherein the patient weight information is input to the input unit (114) or is received from the interface (115) before placing the patient on the patient support device (18), and
wherein the evaluation unit (117) simulates the movements of the operating table (10) with the patient supported thereon before placing the patient on the patient support device (18).

22. The system (100) according to any one of the preceding claims, wherein the evaluation unit (117) is formed to determine the restrictions during operation of the operating table (10) based on at least the patient weight by the evaluation unit (117) simulating movements of the operating table (10) with the patient supported thereon.

23. A method for determining and displaying restrictions during operation of an operating table (10), wherein
information on the weight of a patient is input to an input unit (114), and/or electronic patient weight information is received at an interface (115);
restrictions during operation of the operating table (10) are determined based on at least the patient weight; and
the restrictions are displayed on a display unit (116) before placing the patient on a patient support device (18), in particular a surgical patient support device (18).
